(19) United States
(12) Patent Application Publication
(10) Pub. No.: US 2025/0245630 A1
(43) Pub. Date: Jul. 31, 2025

(54) AUTOMATED POWER OUTAGE DETECTION, REPORTING AND MITIGATION

(71) Applicant: Charter Communications Operating, LLC, St. Louis, MO (US)

(72) Inventor: Patrick Hunter, Saint Charles, MO (US)

(21) Appl. No.: 18/424,762

(22) Filed: Jan. 27, 2024

(51) Int. Cl. G06Q 10/20

(52) U.S. Cl. CPC G06Q 10/20

(57) ABSTRACT

Using at least one hardware processor, obtain, at a network monitoring location, an indication of a putative power failure at a remote network location. Responsive to obtaining the indication, initiate, using the at least one hardware processor, an automated triage process to determine whether the putative power failure is an actual power service failure. Using the at least one hardware processor, issue an alert based on the determination of whether the putative power failure is an actual power service failure.

### FIELD OF THE INVENTION

The present invention relates generally to the electrical, electronic and computer arts, and, more particularly, to networking and network management.

### BACKGROUND OF THE INVENTION

In the monitoring of network environments, such as the monitoring of a network operations center, one of the most common network “events” causing an impact to network performance and functionality at a remote location, such as an office, a warehouse, a technical center, a retail store or other site, is the occurrence of a loss of power/electrical services; typically, commercial (i.e., provided by a third party such as a power company) power/electrical services. Naturally, when power to the site is lost, communications between the monitoring systems and the network components at the site are often interrupted. When this happens, the network monitoring systems are often unaware of the cause of the interruption, such as a loss of power, a failed network device, a downed communication line, and the like. A network user, such as a monitoring agent, operator, administrator, engineer and the like, must typically perform manual triage in order to discover the cause of the loss of communications at that site. This often involves checking alerting mechanisms in the monitoring tools as well as checking the list of active network changes recently implemented or in the progress of being implemented. Once a determination has been made that a network change (e.g., in an enterprise's wide area network being monitored) is not the cause of the issue, network personnel will typically attempt to determine if a power outage occurred. For example, power outage related websites that identify active outages, such as those managed by local/regional power companies, as well as third party power outage sites, are conventionally accessed.

If a determination is made that it is unlikely that a power outage is the cause of the issue, other investigative steps are taken by, for example, engaging local personnel at the site to investigate the issue. This initial triage is important to ensure that non-local resources are not dispatched to a site just to learn that the cause of the failure is a power outage; however, the process is highly manual and time consuming. In sufficiently large networks (for example, networks having hundreds or thousands of remote sites), these types of events typically occur on a daily, if not hourly, basis. Ignoring the issue, however, leads to missed or prolonged network issues. Thus, conventionally, a time-consuming manual check of the relevant websites typically has to be conducted on a regular basis in order to ensure that such power conditions are detected and mitigated. One issue of concern for detection in these manual checks is when power has been restored but a network site remains in a “down” state.

### SUMMARY OF THE INVENTION

Principles of the invention provide automated power outage detection, reporting and mitigation. In one aspect, an exemplary method includes the operations of using at least one hardware processor, obtaining, at a network monitoring location, an indication of a putative power failure at a remote network location; responsive to obtaining the indication, initiating, using the at least one hardware processor, an automated triage process to determine whether the putative power failure is an actual power service failure; and using the at least one hardware processor, issuing an alert based on the determination of whether the putative power failure is an actual power service failure.

In another aspect, an exemplary non-transitory computer readable medium includes computer executable instructions which when executed by a computer cause the computer to perform a method including the steps of: obtaining, at a network monitoring location, an indication of a putative power failure at a remote network location; responsive to obtaining the indication, initiating an automated triage process to determine whether the putative power failure is an actual power service failure; and issuing an alert based on the determination of whether the putative power failure is an actual power service failure.

In still another aspect, an exemplary apparatus includes: a memory; and at least one processor, coupled to the memory, and operative to: obtain, at a network monitoring location, an indication of a putative power failure at a remote network location; responsive to obtaining the indication, initiate an automated triage process to determine whether the putative power failure is an actual power service failure; and issue an alert based on the determination of whether the putative power failure is an actual power service failure.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
improvements to the technical field of network management using a triage and mitigation system configured for triaging a network failure based on a variety of information sources;
improvements to the technical field of network management using a correlation engine trained to determine whether a network fault is caused by a power failure;
improvements to the technical field of network management by refraining from utilizing a network maintenance technician when it is determined that a network outage is due to electrical power loss; and
improvements to the technical field of network management by utilizing a network maintenance technician when it is determined that a network outage is not due to electrical power loss but rather a network fault; the technician can initiate one or more mitigation actions such as a reset, bypass, replacement, repair, and the like.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIG. 10 is a high-level block diagram of a network infrastructure with power monitoring, reporting and mitigation, in accordance with an example embodiment;

FIG. 11 is a flowchart for an example method for monitoring, detecting and mitigating power failures on a network infrastructure, in accordance with an example embodiment;

FIG. 12 is a flowchart for an example method for correlating information indicative of a power status on a network infrastructure, in accordance with an example embodiment;

FIG. 13 shows an exemplary database table in accordance with an aspect of the invention; and

FIGS. 14 and 15 show exemplary power company outage maps useful in connection with aspects of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

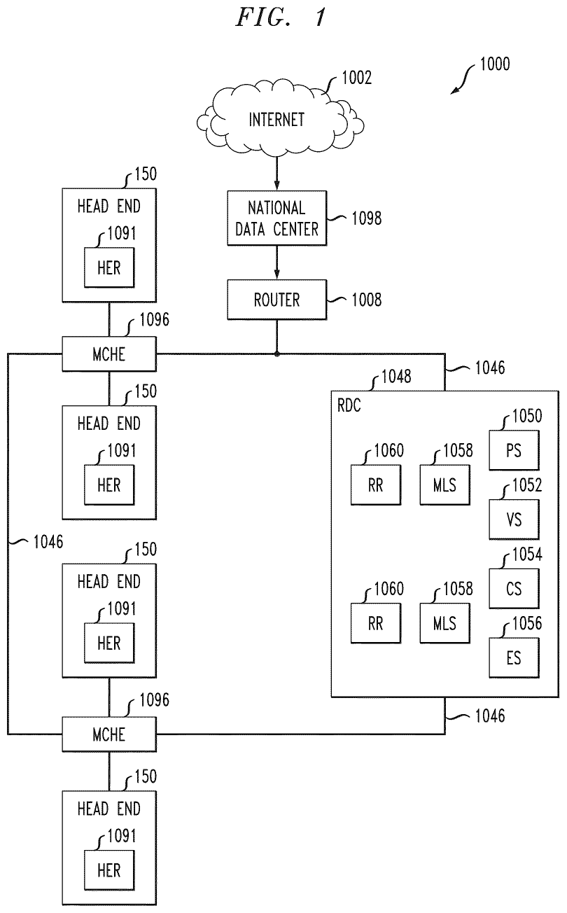

Aspects of the invention are applicable in a variety of networks that are subject to potential power failures. These networks can include, for example, an organization's internal wide area network (WAN). However, in another aspect, these networks can include, for example, a hybrid fiber-coaxial (HFC) network, a fiber to the home (FTTH) network, a fiber to the curb (FTTC) network, or the like. Thus, FIGS. 1-9 depict exemplary aspects of HFC and fiber networks within which aspects of the invention could be employed, it being understood that these are to be taken as exemplary and non-limiting.

[Boilerplate for HFC/FTTC/FTTH] FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

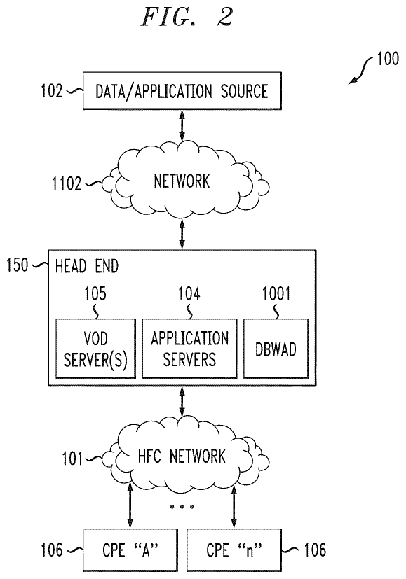

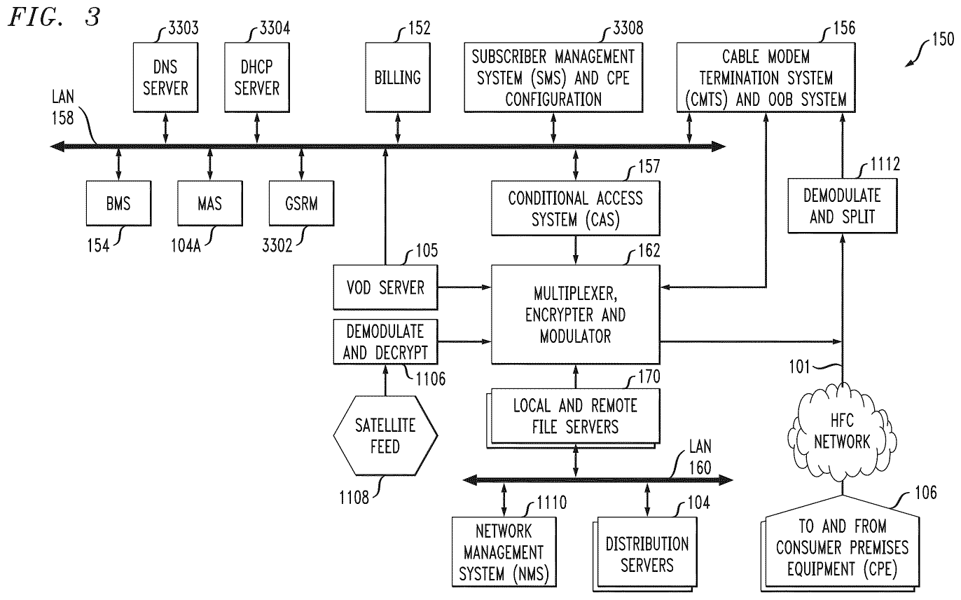

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

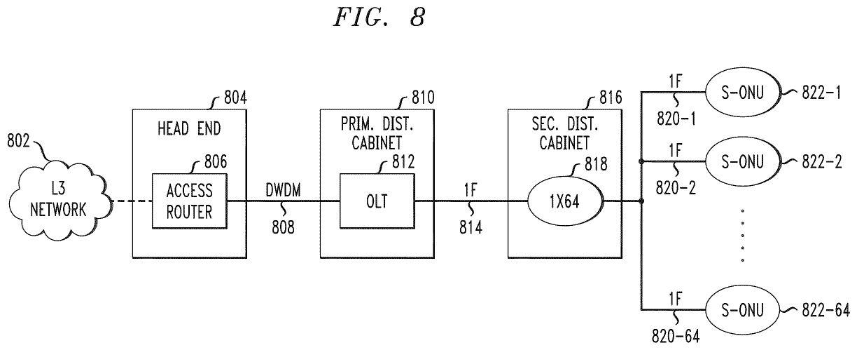

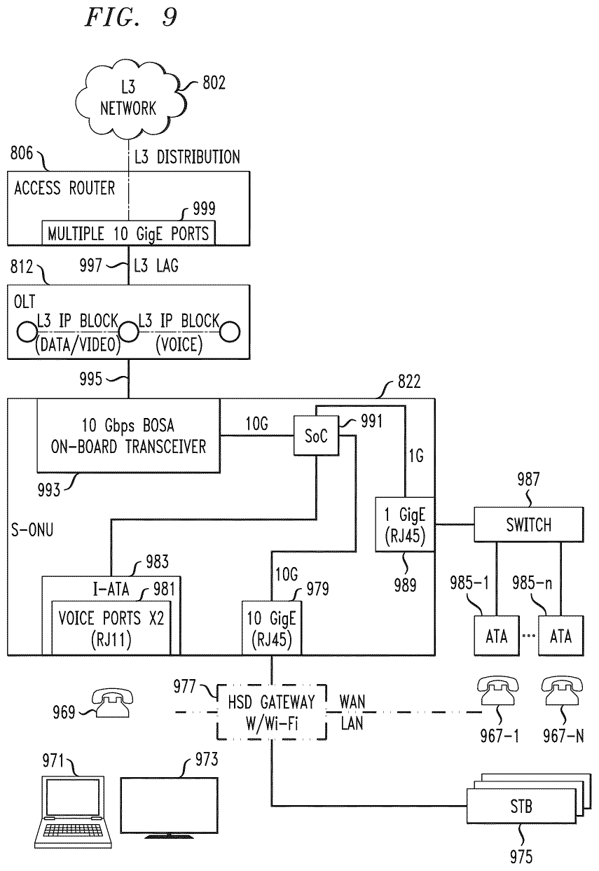

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

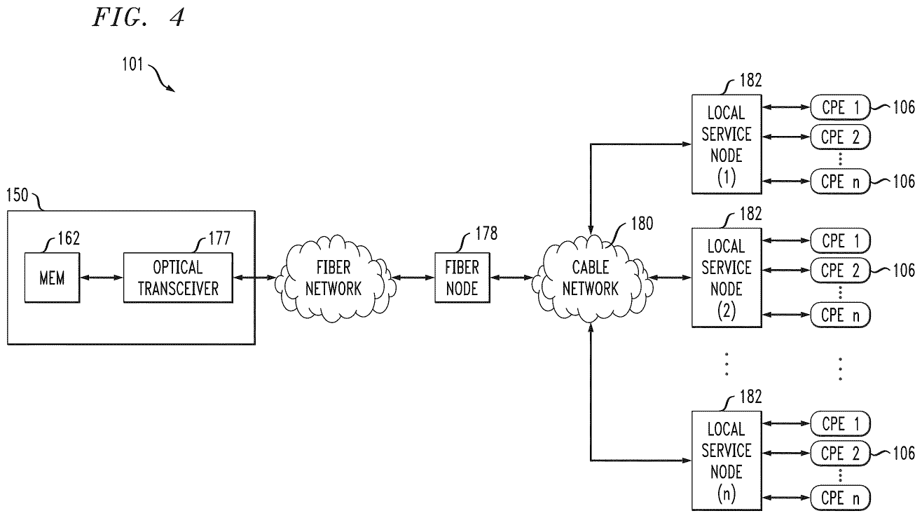

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

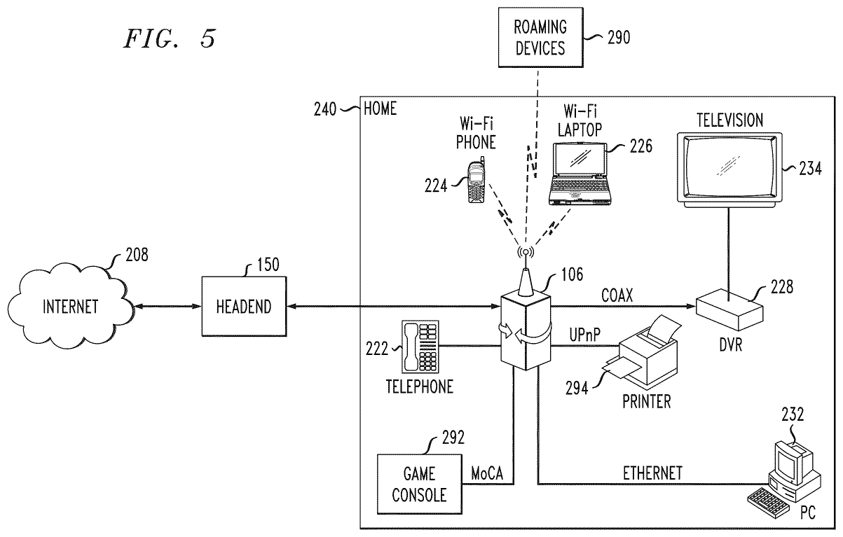

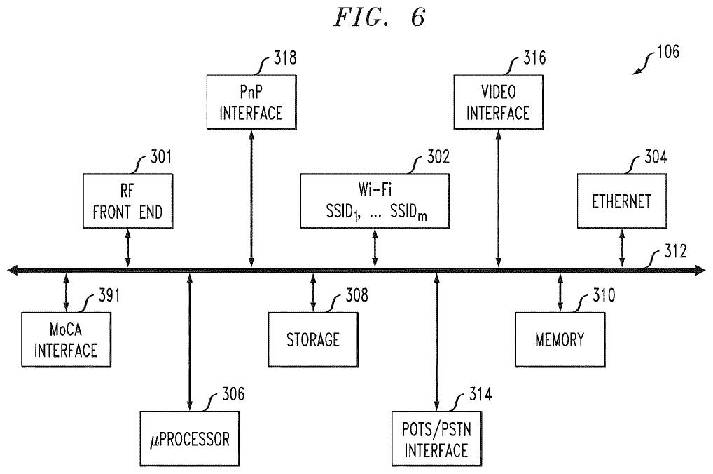

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VOIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Principles of the present disclosure will be described herein in the context of apparatus, systems, and methods for networking and network management. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

Generally, methods and systems are provided for performing automated triage, monitoring and mitigation of power-related events, such as commercial power outages, which cause a loss of communications for network sites (e.g., for an enterprise's internal wide area network (WAN), which might have thousands of sites in the case of a large enterprise, government agency, etc.). Exemplary embodiments improve network performance by more efficiently mitigating the effects of power outages. Moreover, manual labor cycles of network monitoring and repair personnel, such as administrators, engineers and technicians, for addressing power related events, are inherently reduced. It is worth noting that some aspects of the invention can be employed for monitoring any type of power outage, but can be particularly helpful in cases of commercial power outages (i.e., when electrical power is provided to a network site by a third party other than the network operator), since the network operator will typically have less visibility into a third party outage than into an outage caused by its own equipment.

In one example embodiment, a triage is carried out for validating power-related events; the triage is based on multiple resources and is fully automated. In some instances, a software-driven correlation engine is trained to classify network events as being due to a power failure or due to other causes. Messages and alerts are generated to identify the source(s) of the outage as well as to provide notification regarding when the outage appears to have been cleared so that further triage can be performed if the network site remains down. In addition, in one or more embodiments, the system will periodically restart the triage process, such as after a specified period of time, until the power outage is declared as “cleared” by the correlation engine. Once the power outage is declared as being cleared, the monitoring systems and engineers are notified such that communications with the site can be validated as being restored (this can also be determined automatically in some embodiments) and an “all clear” for both the power system and the network functionality can be declared.

If the conclusion of the triage operation is that a power outage is the most likely cause of the network event, an engineer or other user utilizes the monitoring system to determine and report when communications have been restored to the site, ostensibly indicating that the power outage has been repaired. We have found, however, that simply waiting for the “all clear” alert is not sufficient. A significant percentage of the power events will trip breakers, trigger issues with uninterruptible power supply (UPS) appliances, or cause other unexpected anomalies with respect to the network and power systems at the site that will prevent communications and a final issuance of an “all clear.” Note that tripping of breakers and the like can be caused, for example, by transient voltage spikes, transient current spikes, surges, and the like. Note also that one or more embodiments also initiate some form of notification to the business and/or the user base regarding the power event(s).

In some cases, communication with a remote site remains partially operational even after a network alert for a site has been issued. In this case, the remaining communications can provide important data, such as the status of the on-site uninterruptible power supply (UPS) indicating an fault of the input power, indicating that battery services are operating to power at least some of the network appliances (using electrical and network redundancy at the remote site) and the like. In one example embodiment, the system considers the alert data from the site (such as from the on-site UPS) in triaging the network failure, and the same is provided to the correlation engine discussed elsewhere herein.

In one example embodiment, devices, such as network routers and switches, residing at the remote site issue an alert message, known as a Simple Network Management Protocol (SNMP) trap, when the corresponding device is in the process of powering down due to a power failure. This communication is known as a “last gasp” or “dying gasp” communication. In one example embodiment, the system considers “last gasp” or “dying gasp” communications in triaging the network failure. The skilled artisan will be familiar with such “last gasp” or “dying gasp” communications from, for example, the document “DOCSIS® Provisioning of EPON Specifications DPoEv2.0,” DPOE OAM Extensions Specification, DPoE-SP-OAMv2.0-114-190213, © Cable Television Laboratories, Inc., 2011-2019, Feb. 13, 2019, expressly incorporated herein by reference in its entirety for all purposes. Refer especially to Section 7.2 thereof.

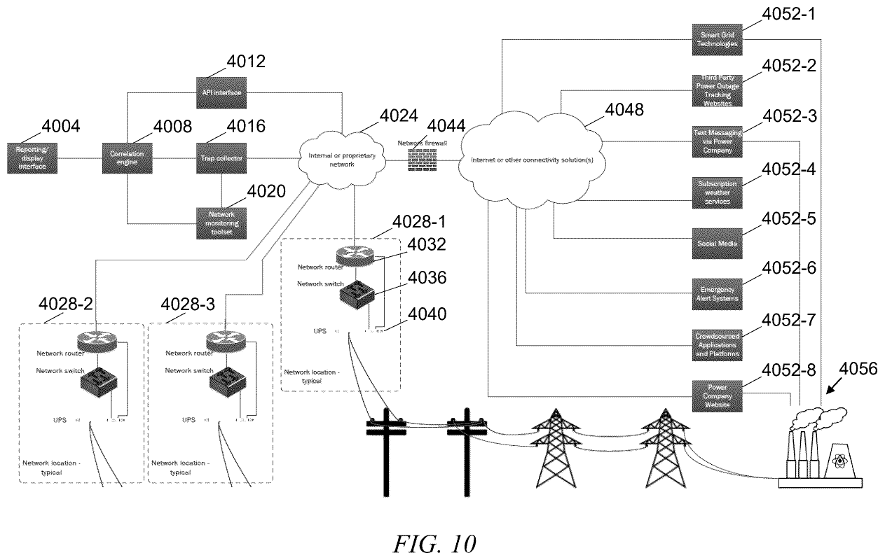

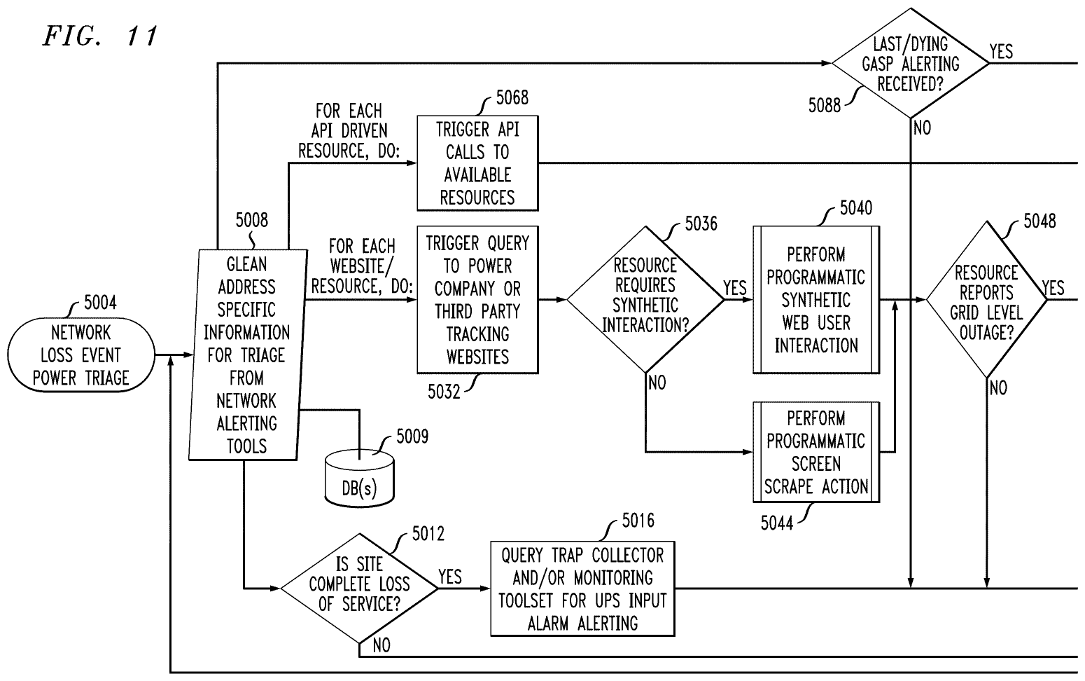

FIG. 10 is a high-level block diagram of a network infrastructure with power monitoring, reporting and mitigation, in accordance with an example embodiment. A network 4024, such as an enterprise network, a metropolitan area network, a wide area network, an internal or proprietary network and the like, provides network connectivity between multiple computers—for example, between one or more data centers, such as one or more national data centers, one or more regional data centers, and the like, and one or more remote network sites 4028-1, 4028-2, 4028-3. The network 4024 communicates with the Internet or other connectivity solution(s) (e.g., broadband network, network of networks, etc.) 4048 via a firewall 4044. The data centers and remote network sites operate primarily via main electric power provided by a utility company 4056, a local power generator (not shown) and the like. When the main power fails, the devices of the data centers and remote network sites typically switch over to a backup power source, such as a local generator, local batteries, and the like. While the backup power may keep some network devices running, other devices residing at the data centers and remote network sites may simply power down in response to the main power failure.

It is worth noting that one or more embodiments apply to both commercial power (e.g., from an electric utility) and to main power generated by a local generator. However, one or more embodiments may be more useful for commercial power loss, as opposed to loss of power from a local generator, since there would typically be more visibility into an outage associated with a local generator. Furthermore, typically, the start-up of a local generator would necessarily indicate that the automatic transfer switch (ATS) and associated detection circuits have detected a loss of (commercial) input power and cause the generator to start and throw the ATS.

In one example embodiment, a correlation engine (CE) 4008 receives information indicative of a power failure from a variety of sources. For example, network traps from the networks 4024, 4048; notifications from weather subscriptions; notifications obtained via an API of an electric utility company; texts and social media posts; information from a web site such as dslreports dot com or downdetector dot com (notation “dot” used instead of “.” to avoid inclusion of browser-executable code in the text of the patent application), and the like are received by the CE 4008. Based on the received information, the CE 4008 determines whether a network event, such as a network failure, is power related. In particular, information that is indicative of whether an external power outage has occurred is obtained via the Internet or other connectivity solution(s) 4048 from websites and web services, such as smart grid technologies 4052-1, third-party power outage tracking websites 4052-2, text messaging via a power company 4052-3, subscription weather services 4052-4, social media platforms 4052-5, emergency alert systems 4052-6, crowdsourced applications and platforms 4052-7, and/or power company websites 4052-8. Alternatively (i.e., instead of human interaction, screen scrape, or synthetic interaction-see discussion of 5036, 5040, 5044 below), application programming interfaces (APIs) 4012 can be used to access information from the websites and web services 4052-1, 4052-2, 4052-3, 4052-4, 4052-5, 4052-6, 4052-7, 4052-8 and to provide the obtained information to the CE 4008. Elements 4052-1, 4052-2, 4052-3, 4052-4, 4052-5, 4052-6, 4052-7, 4052-8 thus represent resources that permit inferring a power outage or perhaps even making an “absolute determination” of a power outage (e.g., information obtained directly from a power company).

It is worth noting that the smart grid is an enhancement of the conventional electrical grid, using two-way communications and distributed intelligent devices; the skilled artisan will be familiar, for example, with Gridmetrics® technologies (registered mark of Cable Television Laboratories, Inc., Louisville, CO, USA).

Similarly, a trap collector 4016 works in conjunction with network monitoring toolset 4020 and collects, for example, system log (syslog) data, also known as traps, from network routers 4032, network switches 4036, UPSs 4040, network firewall 4044 and the like. The traps are analyzed for information indicative of a power related failure. The skilled artisan will be familiar with current trap collector and network monitoring toolset software and, given the teaching herein, will be able to adapt same to implement one or more embodiments. The skilled artisan will be familiar with routers, switches, uninterruptible power supplies (UPS), firewalls, other network appliances, and the like sending system logging data in the form of traps to trap collectors (typically, pro-actively, i.e., not responsive to polling).

Further regarding social media posts, in a non-limiting example, a user of a social media platform could post that the user's power has gone out at 123 Main Street and it could be determined that this location is close to the impacted network site. In some cases, parsing routines and natural language processing could be used to extract meaning from social media posts, texts, and the like.

In one example embodiment, the correlation engine 4008 is rules-based and uses predefined rules to determine whether a power related failure has occurred based on the obtained information. Additionally or alternatively, the correlation engine 4008 can use a machine learning model to identify power outages based on the information described above. (The machine learning model is trained using, for example, supervised learning to detect power failures based on known examples of power failures and their corresponding information data patterns.) The reporting and display interface 4004 is, for example, a graphical user interface (GUI) on a client device that enables an administrator or other user to configure the network infrastructure to monitor for, detect, and report network outages, including power related failures (but in other embodiments could also be text-based as opposed to a GUI and still have appropriate similar functionality). For example, the API interfaces 4012 can be configured via the reporting and display interface 4004 to access specific websites and web services 4052-1, 4052-2, 4052-3, 4052-4, 4052-5, 4052-6, 4052-7, 4052-8 and the correlation engine 4008 can be configured to report detected or suspected power failures to the reporting and display interface 4004.

Thus, plant 4056 can be any kind of commercial power plant such as fossil-fuel fired, nuclear, wind powered, solar powered, hydroelectric, or the like. The plant provides power to location 4028-1 over a power grid including high tension lines with transformers to local power lines. Facility 40-28-1 can be a building, enclosure, etc. with known UPS switch and router. network 4024 can be a corporate (or other organization) information technology WAN, an HFC/fiber network, or the like. Known firewalls and known principles of APIs can be employed. The trap collector and toolset are known software tools. The correlation engine is discussed elsewhere herein.

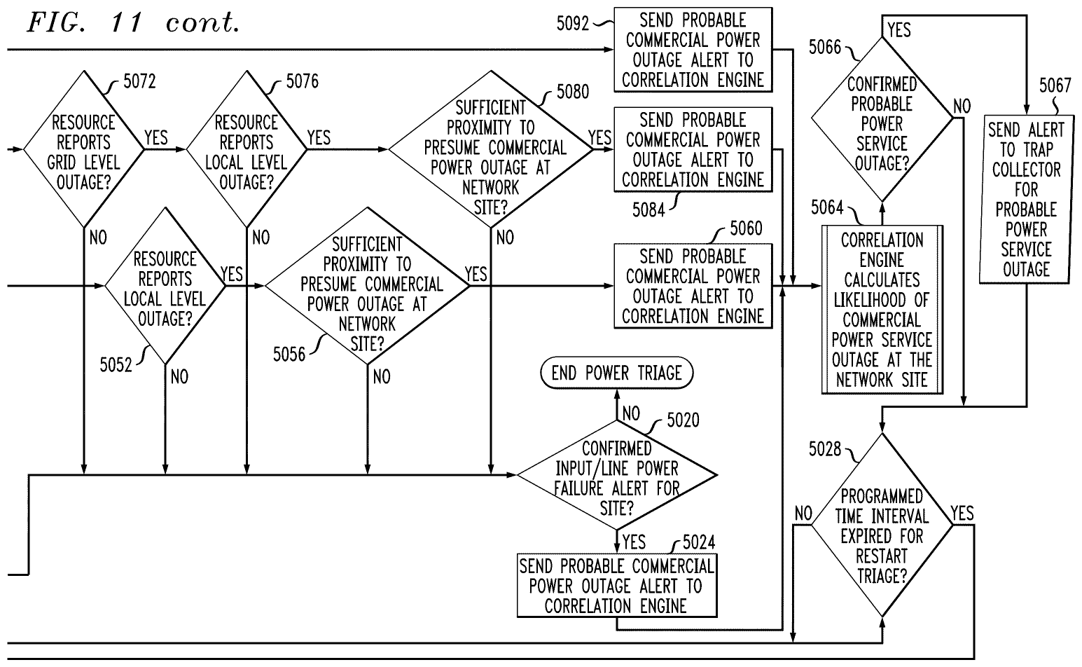

FIG. 11 is a flowchart for an example method for monitoring, detecting and mitigating power failures on a network infrastructure, in accordance with an example embodiment. In the illustrated example, network loss event power triage is initiated (operation 5004). Address-specific information, such as the physical address of a network site suffering a network failure, is gleaned from, for example, network alerting tools (operation 5008). A number of paths are then followed in parallel or serially to infer whether a power related event has occurred that has caused the network failure. Generally, all the paths can be followed in parallel, in series, or in a mixture of parallel and series, or a subset of paths can be followed in parallel, in series, or in a mixture of parallel and series.

In a first path of execution, a check is performed to determine if the given remote site is suffering from a complete loss of service (operation 5012). If the given remote site is suffering from a complete loss of service (YES branch of operation 5012), the trap collector 4016 is queried and the collected traps are obtained. In addition, or alternatively, the monitoring toolset can be queried to determine if an alarm has been detected, such as a UPS input alarm (operation 5016). A check is performed to determine if an input/line power failure alert for the given remote site has been confirmed (operation 5020). If the input/line power failure alert for the given remote site has been confirmed (YES branch of operation 5020), a probable power outage alert is sent to the correlation engine 4008 (operation 5024) and the method proceeds with operation 5064; otherwise (NO branch of operation 5020), the method 5000 ends.

If the given remote site is not suffering from a complete loss of service (NO branch of operation 5012), a check is performed to determine if a programmed time interval for restarting the triage has expired (operation 5028). If the programmed time interval for restarting the triage has not expired (NO branch of operation 5028), operation 5028 is repeated; otherwise, operation 5008 is repeated.

In a second path of execution, a query to a power company and/or to one or more third-party tracking websites is triggered (operation 5032). A check is performed to determine if a selected resource requires a synthetic interaction (operation 5036). If a selected resource requires a synthetic interaction (YES branch of operation 5036), a programmatic synthetic web user interaction is performed (operation 5040) and the method proceeds with operation 5048; otherwise (NO branch of operation 5036), a programmatic screen scrape action is performed to gather relevant power-related information from the given website or web service (operation 5044) and the method proceeds with operation 5048. It is worth noting that a “synthetic web user interaction” is an alternative to a screen scrape, and can include, for example, a “bot” or the like simulating human interaction with the web site. “Synthetic monitoring” in a more general sense describes programmatically emulating a human interaction with a web page to detect behavioral anomalies with respect to the function and latency of the website from the user perspective. In this aspect, one or more embodiments do not use the synthetic calls for monitoring the website, but rather to programmatically generate an output which can be parsed for useful information.

During operation 5048, a check is performed to determine if the resource reports a grid-level outage. If the resource reports a grid-level outage (YES branch of operation 5048), a check is performed to determine if the resource reports a local-level outage (operation 5052); otherwise (NO branch of operation 5048), the method proceeds with operation 5020.

During operation 5052, if the resource reports a local-level outage (YES branch of operation 5052), a check is performed to determine if there is sufficient proximity (e.g., geographic proximity) to presume a power outage (such as a commercial power outage) at the network site (operation 5056); otherwise (NO branch of operation 5052), the method proceeds with operation 5020.

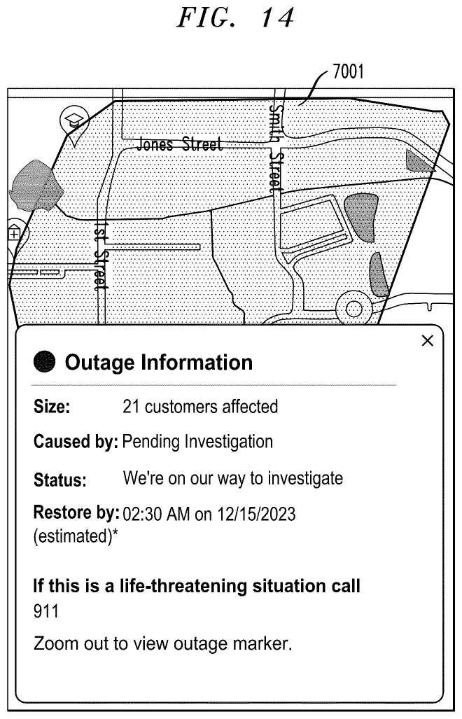

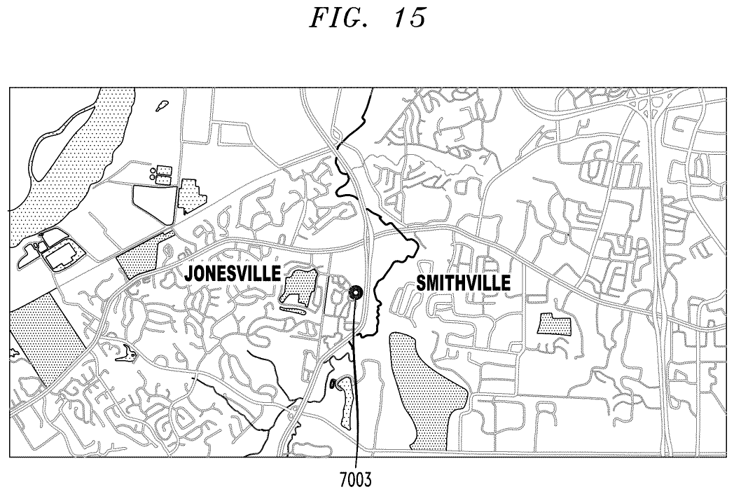

Furthermore regarding proximity, one or more embodiments consider geographic proximity. Refer to FIGS. 14 and 15. In some instances, as shown in FIG. 14, an electric utility will provide an outage map showing the entire geographic area 7001 impacted by an outage. In such a case, a detailed assessment of proximity is not needed; it can simply be determined whether the network location is located in the impacted area. On the other hand, in some instances, as shown in FIG. 15, an electric utility will provide an outage map showing a “push-pin” 7003 and more effort is needed to select a region that is impacted by the outage; for example, within 1500 feet (457 m), within 1 mile (1.6 km), within 3 city blocks, and so on (e.g., a predetermined radius in terms of linear measure or city blocks). In one or more embodiments, the skilled person can determine an appropriate value for geographic proximity heuristically by examining historical “push-pin” data where there is a known outage and a suitable radius in is picked so as to find most outages while minimizing false alarms (i.e., cases where there is an IT/HFC/fiber network problem, not a power company problem). In some instances, machine learning can be used by training an artificial neural network or other machine learning system on historical data annotated by a human expert and then using it to carry out inference on new data to estimate a suitable geographic proximity to a “push-pin” outage.

During operation 5056, if there is sufficient proximity to presume a power outage at the network site (YES branch of operation 5056), a probable power outage alert is sent to the correlation engine 4008 (operation 5060) and the method proceeds with operation 5064; otherwise (NO branch of operation 5056), the method proceeds with operation 5020.

In a third path of execution, API calls to available resources are triggered (operation 5068) and a check is performed to determine if the resource reports a grid-level outage (operation 5072). If the resource reports a grid-level outage (YES branch of operation 5072), a check is performed to determine if the resource reports a local-level outage (operation 5076); otherwise (NO branches of operations 5072, 5076), the method proceeds with operation 5020.

During operation 5076, if the resource reports a local-level outage (YES branch of operation 5076), a check is performed to determine if there is sufficient proximity to presume a power outage, such as a commercial power outage, at the network site (operation 5080); otherwise (NO branch of operation 5076), the method proceeds with operation 5020.

During operation 5080, if there is sufficient proximity to presume a power outage at the network site (YES branch of operation 5080), a probable power outage alert is sent to the correlation engine 4008 (operation 5084) and the method proceeds with operation 5064; otherwise (NO branch of operation 5080), the method proceeds with operation 5020. In steps 5056 and 5080, proximity can be determined, for example, as discussed above. When a power company or other source of information provides an outage map showing the entire geographic area impacted by an outage, a detailed assessment of proximity is not needed; it can simply be determined whether the network location is located in the impacted area. On the other hand, when an electric utility or other information source provides an outage map showing a “push-pin,” a predetermined radius can be predetermined based on human expert judgment, inferred in real-time by machine learning, or the like.

In a fourth path of execution, a check is performed to determine if a “last gasp” or “dying gasp” communication has been received (operation 5088). If a “last gasp” or “dying gasp” communication has been received (YES branch of operation 5088), a probable power outage alert is sent to the correlation engine 4008 (operation 5092) and the method proceeds with operation 5064; otherwise (NO branch of operation 5088), the method proceeds with operation 5020.

During operation 5064, a calculation of a likelihood of a commercial power service outage at the network site is made by the correlation engine 4008 based on the obtained information and the method proceeds to decision block 5066 to determine whether a probable power service outage has been confirmed. If YES, send an alert to the trap collector for a probable power service outage in step 5067 and proceed to decision block 5028. If NO, proceed directly to decision block 5028. A suitable tolerance can be applied to the likelihood at 5064, 5066; for example, if there is a 99.8% (or more) chance that the fault is due to a commercial power outage, refrain from employing/dispatching/utilizing a technician; merely flag the outage. Note that 99.8% is a non-limiting example.

In one or more embodiments, a confidence threshold is defined for assuming that there is an outage. Similar techniques could be employed as were mentioned above in connection with the “push-pin” case. In one or more embodiments, the skilled person can determine an appropriate value for the confidence threshold heuristically by examining historical data where there are known outages and known non-outage problems and a suitable confidence threshold (e.g., 90%, 95%, 98%, 99%, 99.8% and so on) is picked so as to find most outages while minimizing false alarms (i.e., cases where there is an IT/HFC/fiber network problem, not a power company problem). In some instances, machine learning can be used by training a neural network or other machine learning system on historical data annotated by a human expert and then using it to carry out inference on new data to estimate a confidence level that there is an actual power system outage. Such a confidence threshold can be applied at any one, some, or all of decision blocks 5092, 5084, 5060, 5024, and 5066. As noted above, generally, all the four paths shown in FIG. 11 can be followed in parallel, in series, or in a mixture of parallel and series, or a subset of paths can be followed in parallel, in series, or in a mixture of parallel and series. No decision block(s) is/are shown in FIG. 11, with the understanding that all four paths could be followed in parallel, for example; however, other embodiments could employ logic or machine learning to select what path(s) to follow and in what order.

In one example embodiment, if a determination is made that a power outage is not likely to have occurred, then conventional network failure mitigation actions are initiated. If a determination is made that a power outage is likely to have occurred, then power failure mitigation actions are initiated. In one example embodiment, no power failure mitigation action is taken until a determination is made that the power has been restored. Once power has been restored, if network failures persist, a technician or other repairperson is dispatched to the remote network site where, for example, UPS line power and output power is checked, a UPS is tested and replaced, reset, and/or repowered and the like.

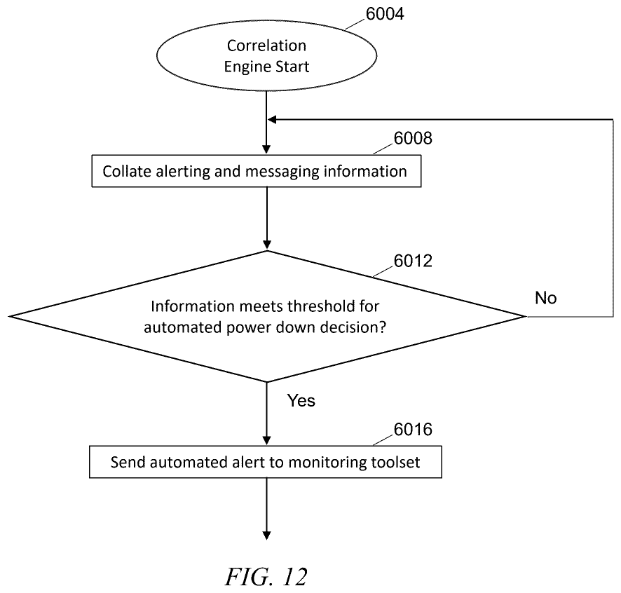

FIG. 12 is a flowchart for an example method for correlating information indicative of power status in a network infrastructure, in accordance with an example embodiment. In one example embodiment, a correlation engine 4008 is started (operation 6004). Alerts, messages and other information regarding the power status of the network infrastructure is collected and/or collated (operation 6008). The correlation engine 4008 processes the obtained information and determines whether a power failure can be inferred from the processed information (operation 6012). In one example embodiment, the obtained information is compared to the rules of a rules-based correlation engine 4008. In one example embodiment, the obtained information is processed by a trained neural network of the correlation engine 4008. If a power failure is inferred from the collated information (YES branch of operation 6012), an automated alert is sent, for example, to a monitoring toolset (operation 6016); otherwise, operation 6008 is repeated to collect/collate and process additional alerts, messages and other information, if available. Furthermore, it will be appreciated that actions can be taken or not taken depending on whether it is believed with a sufficient degree of confidence that a network outage (e.g., of an enterprise WAN) is due to a power outage or another factor. If the former, it may be appropriate to merely note the situation and not dispatch a technician or the like, whereas in the latter case, dispatching a technician (or utilizing an on-site technician) may be appropriate. FIG. 12 can be carried out, for example, by the daemon/listener discussed elsewhere herein or by a separate module.

When a technician is employed, a variety of practical actions can be taken. For example, an indicator light can be checked on various pieces of equipment, a UPS can be checked for line power in and conditioned power out, UPS battery and/or inverter can be tested and replaced as needed, a UPS could be bypassed (for example, if believed to be defective) and supported equipment could be plugged directly into a wall receptacle, a reset button can be depressed, a component can be unplugged and re-plugged, and so on. Generally, any type of repair or replacement of one or more components can be supported.

By way of review and provision of additional information, it will be appreciated that ideally, a power outage can be discovered by receiving network telemetry from an uninterruptible power supply (UPS) or backup power unit. One or more embodiments advantageously help to determine whether the power outage is caused by a loss of commercial power, in which case dispatching a technician can be avoided, or due to an internal fault, in which case a technician may need to be dispatched. In one or more embodiments, a correlation engine employs network trap data from on-site UPS or other network elements. One or more embodiments leverage existing sources of information such as 4052-1 through 4052-8 and in some instances, hook into those information sources via an API to avoid the need for human-browser interaction.

In some instances, a daemon or the like continuously monitors for network issues and initiates the process at 5004 when an issue is detected.

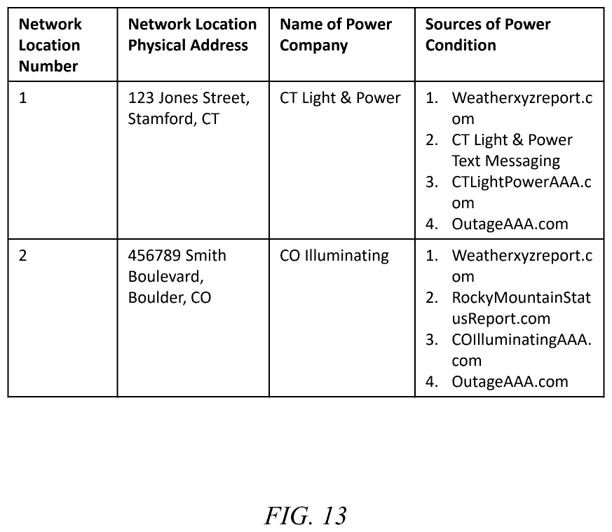

FIG. 13 shows an exemplary database table in accordance with an aspect of the invention. For brevity, only two network locations are shown, namely, Network Location Number 1 in Stamford, CT and Network Location Number 2 in Boulder, CO. The first location is serviced by CT Light & Power and the second location is serviced by CO Illuminating. Each location has some sources for determining power condition. Each can employ a weather web site and an outage web site, and the power company's own web site. For Location Number 1, the power company also provides text alerts. For Location Number 2, a regional Rocky Mountain web site is also available. Note that typical databases may have tens, hundreds, or thousands of network locations. Note that each location is shown in the example as having four sources for determining power condition, but generally, there can be more or fewer sources and different locations can have different numbers of sources. The table of FIG. 13 can reside anywhere, and is typically a different data structure than a table that correlates the device identifier with the address. For illustrative convenience, several databases 5009 are shown in a single symbol. The databases can re relational databases accessed by SQL queries, graph databases, or the like.

A list or other database or data structure can also be used to store network data that is captured during logging of messages from network appliances such as from a trapping process or the like as discussed elsewhere herein. This structure can also store the SNMP system location information which can be treated as “source of truth” address information.

Correlation engine-rules-based: Consider an exemplary rules-based implementation of the correlation engine 4008. In this aspect, rules can be implemented in software; for example, as a series of comparison statements. For example, it could be determined how many sources of information, such as 4052-1 through 4052-8, were available for a given network location, and a certain percentage of the available sources would have to be positive to concluded that there was indeed a power outage.

Correlation engine-machine learning based: Consider an exemplary machine learning-based implementation of the correlation engine 4008. In this aspect, a machine learning system, such as a neural network, pattern recognition, or the like, is trained on data annotated by a human expert. For example, develop a training corpus by looking at many sources of information, such as 4052-1 through 4052-8, for a considerable period of time, and have a trained human annotator annotate the historical data with whether there was an actual outage. Train the system on this data and then use it to carry out inference on actual data.

Either implementation of the correlation engine can be implemented with the assistance of a database (accessed, for example, with a GUI such as 4004) to collect and store information such as training data or data that can be used to heuristically determine the percentage of the available sources that would have to be positive to concluded that there was indeed a power outage.

It is worth noting that in some cases, recognizing a power outage can lead to possibly preventing a truck roll by a field operations technician due to our high probability of the knowledge that the power was out at a certain network location. However, in some cases, the opposite can be true: when the power is out, a truck rolls to either connect the standby power supply to the truck's inverter or to an external gas-powered generator.

Even in such cases, however, there is still value for the field operations team in knowing with a high level of certainty that commercial power is out, because the knowledge could still shape what decisions are made on the fly. For example, if the power is out for an area, perhaps more than one power supply is without commercial power. In that event, at least two trucks or more than one generator might be necessary. If the power company is reporting a relatively short restoration time, perhaps only a single truck with an inverter is necessary in the short run.

As noted above, aspects of the invention are applicable in a variety of networks that are subject to potential power failures. These networks can include, for example, an organization's internal wide area network (WAN) such as 4024. However, in another aspect, network 4024 can include, for example, a hybrid fiber-coaxial (HFC) network, a fiber to the home (FTTH) network, a fiber to the curb (FTTC) network, or the like. In this aspect, power supplies can be located outdoors such as on a utility (e.g., curbside, side- or rear-easement installations) pole or the like, or in pedestals or cabinets, and can power amplifiers, nodes, etc., whereas power supplies in the internal WAN example may be indoors. The response to a commercial power outage may be different in the case of an internal WAN versus an HFC or fiber network or the like. For example, in the HFC/fiber case, depending on the data gathered, if it is determined that there is likely a commercial power outage, it may be desirable to roll a truck to connect the truck's inverter to provide power to the impacted components or to roll one or more trucks to connect portable gasoline-powered generators to provide power to the impacted components. It is worth noting that even in the case of fiber to the home/premises (FTTH), there is still a potential concern in the case of a suspected commercial power outage at the home/premises because if the outage is not due to a commercial power outage it may be necessary to dispatch a technician to find a broken fiber or other FTTH network issue.

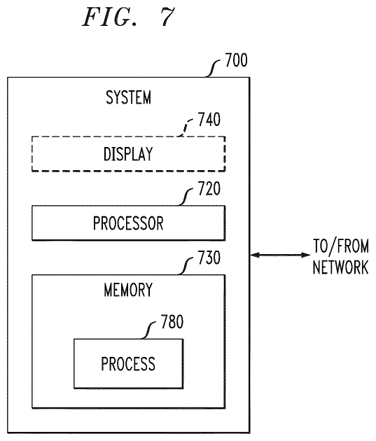

Given the discussion thus far, it will be appreciated that, in general terms, an exemplary method, according to an aspect of the invention, includes the step 5004 of, using at least one hardware processor such as 720 in FIG. 7 discussed elsewhere herein, obtaining, at a network monitoring location (e.g., a data center), an indication of a putative power failure at a remote network location such as 4028-1, 4028-2, 4028-3. This step can be carried out, for example, with the daemon as discussed elsewhere herein. A further step includes, responsive to obtaining the indication, initiating, using the at least one hardware processor, an automated triage process to determine whether the putative power failure is an actual power service failure. This can be carried out, for example, according to the flow chart of FIG. 11, using the correlation engine 4008. A further step includes, using the at least one hardware processor, issuing an alert based on the determination of whether the putative power failure is an actual power service failure. For example, use the interface 4004 to issue the alert. (Note also the alerts 5092, 5084, 5060, 5024 as discussed elsewhere herein.)

As used herein, an “alert” should be broadly understood to include a message, data entry, or the like indicating the result of the determination of whether the putative power failure is an actual power service failure.

As used herein, a “putative” power failure means there is some occurrence that could indicate a power failure which is to be evaluated with the correlation engine to determine if it corresponds to an actual power service failure (i.e., failure service of delivery by the electrical utility provider as distinguished from any electrical failure at all (some of which could be unrelated to successful service delivery by the electrical utility provider)).

Note that the correlation engine can include, for example, the logic that implements step 5064, 5066 as well as a module connected to that logic that triggers the input/output and implements the logic/comparison statements in FIG. 11 and passes same to the logic that implements step 5064, 5066. When blocks 5092, 5084, 5060, 5024 mention sending alerts to the correlation engine, this can be understood as the module portion of the engine communicating with the portion of the engine corresponding to the logic that implements step 5064, 5066.

Step 5008 can be implemented, for example, using a SQL or other query to DB 5009. Decision blocks such as 5088 can be implemented, for example, using conditional statements from a high-level programming language that is compiled or interpreted into executable code to implement the correlation engine.

In one or more embodiments, when the determination is that there is an actual power service failure (YES branch of block 5066), a further step includes refraining from dispatching a remote technician to the remote network location based on the determination. In this aspect, the alert could be, for example, that the outage is due to commercial outage and service will be restored when commercial power comes back.

In some such embodiments, the network monitoring location and the remote network location are connected by an enterprise wide area network 4024.

In other such embodiments, the network monitoring location and the remote network location are connected by at least one of a hybrid fiber-coaxial network, a fiber to the curb network, and a fiber to the home network (see FIGS. 1-9), and the refraining is further responsive to obtaining an indication that the actual power service failure is projected to be over in a predetermined time period. For example, if there is a commercial outage, a truck can be rolled to provide backup power unless there is good evidence the outage will be brief, such as an estimated restoration time from the power company. A suitable threshold can be set heuristically, such as the amount of time it will take the truck to reach the site and make repairs, possibly with some margin such as ½ hour or the like.

In some cases, the determination is that there is not an actual power service failure (NO branch of 5066), and a further step includes dispatching a remote technician to the remote network location based on the determination. Such a technician can be, for example, a technician with expertise in the network per se. This can be done for both the enterprise WAN case and the HFC/FTTH/FTTC case(s).

In some cases, the determination is that there is an actual power service failure (YES branch of block 5066), and a further step includes dispatching a remote technician to the remote network location based on the determination. Such a technician can be, for example, a technician with expertise in connecting a backup/portable power supply. In the case of an enterprise WAN, dispatching a technician in the case of a power failure might be limited to important sites, while in the case of HFC/FTTH/FTTC, dispatching may be a default approach.

Referring to the top path in FIG. 11 (including decision block 5088), in at least some instances, the automated triage process includes checking whether a dying gasp message has been received from the remote network location.

Referring to the second from top path in FIG. 11 (including block 5068), in at least some instances, the automated triage process includes consulting a plurality of external resources via API calls.

Referring to the second from bottom path in FIG. 11 (including block 5032), in at least some instances, the automated triage process includes consulting a plurality of external resources via at least one of screen scraping and synthetic web interactions.

Referring to the bottom path in FIG. 11 (including decision block 5012), in at least some instances, the automated triage process includes checking at least one of a trap collector 4016 and a network monitoring toolset 4020.

Referring to the second from top path in FIG. 11 (including block 5068) and/or the second from bottom path in FIG. 11 (including block 5032), in at least some instances, the automated triage process includes consulting a plurality of external resources including one or more of third party power outage tracking web sites 4052-2, power company text messages 4052-3, subscription weather services 4052-4, social media 4052-5, emergency alert systems 4052-6, and power company web sites 4052-8. Some embodiments can additionally or alternatively use smart grid technologies 4052-1 and/or crowdsourcing 4052-7. In one sense, social media 4052-5 is a subset of crowdsourcing. Some embodiments could employ a social media “app” about power outages.

In one or more embodiments, the automated triage process includes consulting at least social media 4052-5, and a further step includes applying natural language processing (NLP) with the at least one processor to understand sentiment of social media posts (e.g., using known parsing languages and NLP software).

As noted, the correlation engine can be rules-based and/or machine learning-based (refer to discussions of machine learning, confidence levels, and the like elsewhere herein).

One or more embodiments further include consulting a database 5009 to determine a geographic location of the remote network location; the automated triage process then includes consulting a plurality of external resources (e.g., 4052-1 through 4052-8) based on the determined geographic location. Thus, in one or more embodiments, network location addresses are maintained in a database, which is optionally populated with SNMP data. As noted, the SNMP system location information can be treated as “source of truth” address information. For example, query the device where it is located, based on a human programming the device what to say. Various approaches can be used to populate and maintain a list of all sites to reference. The device can be treated as a source of truth, with SMNP polling to pull the data into a database 5009. Database 5009 can be located in many different places. This database 5009 can be used when there is an indication of an outage, to look up the device and see where the device is physically located.

In one or more embodiments, the automated triage process includes: consulting at least one external resource 4052-1, . . . , 4052-8 providing a point location of a power failure; and determining whether the remote network location is geographically proximate the point location. Refer to the discussion of geographic proximity above using, for example, a predetermined radius, machine learning, or the like.

In another aspect, an exemplary method further includes determining a type of remote technician to dispatch to the remote network location based on the determination of whether the putative power failure is an actual power service failure (e.g., if actual power service failure, discuss technician who can hook up truck to provide backup power; if not actual power service failure, discuss technician who can fix the network per se).

In another aspect, an exemplary method further includes implementing a daemon, an interface routine, and a correlation engine on the at least one processor; then, the step of obtaining the indication of the putative power failure is carried out using the daemon; the step of initiating the automated triage process is carried out using the correlation engine; and the step of issuing the alert is carried out using the interface routine. The interface routine can include, for example, the reporting and display interface 4004 as discussed above, and can also include code to implement the alerts 5092, 5084, 5060, 5024 as discussed elsewhere herein (refer to discussion of the logic that implements step 5064, 5066 and the module connected to that logic that triggers the input/output and implements the logic/comparison statements in FIG. 11 and passes same to the logic that implements step 5064, 5066).

As used herein, reference to at least one processor includes one or more processors, and if a first step is carried out by one of the one or more processors a subsequent step can be carried out with another of the one or more processors and both steps should be understood as being carried out with the recited “one or more processors.”

Referring again to element 5004, in one or more embodiments, a daemon or similar process listens and is triggered by any type of suspicious network event. For example, whenever there is an event, go through the flow chart in FIG. 11. In one or more embodiments, it will typically be worth analyzing any event that indicates something is broken (e.g., notification received by SNMP). In one or more embodiments, obtain an SNMP indicating a potential problem, and the SNMP message identifies the network element with the problem. Then, consult the database 5009 to find the location of that piece of equipment (for example, look up in the database to determine that the router that is experiencing problem is at 123 Main Street, Smithville, CT).

An SNMP trap is a message that is sent from a network device to an SNMP management system without being solicited by the system. The trap is triggered when a specific event or condition occurs on the device, such as a link going down, an authentication or a power failure. A suitable SNMP message can be sent from a client to an SNMP server to warn of an alert condition, in the form of an SNMP trap, which is a type of SNMP protocol data unit (PDU). Unlike other PDU types, with an SNMP trap, an agent can send an unrequested message to the manager to notify the manager about an important event. The “Dying Gasp” discussed elsewhere herein indicates, for example, that one of the following unrecoverable condition has occurred: Reload; Power failure or removal of power supply cable.

Referring again to decision block 5020, in one or more embodiments, note the NO branches leading to 5020, which, in the depicted example, is an overriding qualifier. That is to say, if there is a UPS device that has detected a loss of input power from the power utility, that can be treated as an overriding factor that strongly suggests a commercial outage regardless of the other logic.

In another aspect, a non-transitory computer readable medium includes computer executable instructions which when executed by a computer cause the computer to perform a method including carrying out or otherwise facilitating any one, some, or all of the method steps described herein.

In a further aspect, an exemplary apparatus includes a memory (e.g., 730); and at least one processor (e.g., 720), coupled to the memory, and operative to carry out or otherwise facilitating any one, some, or all of the method steps described herein.

In at least some instances, the apparatus further include a network interface coupled to the at least one processor. The network interface is suggested by the double-headed arrow in FIG. 7, and can be implemented by known hardware/firmware/software components such as a network interface card and the like. The network monitoring location is connected to the remote network location by an enterprise wide area network or the at least one of a hybrid fiber-coaxial network, a fiber to the curb network, and a fiber to the home network using the network interface.

One or more embodiments of the apparatus optionally include distinct software modules as described elsewhere herein; for example, a daemon module, a correlation engine module, and an interface routine module, and optionally a database module, which then carry out the corresponding steps as described herein. The modules can include high-level code that implements the described logic and is then compiled or interpreted into computer/processor executable code.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC (application-specific integrated circuit) or FPGA (field-programmable gate array) rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
using at least one hardware processor, obtaining, at a network monitoring location, an indication of a putative power failure at a remote network location;
responsive to obtaining the indication, initiating, using the at least one hardware processor, an automated triage process to determine whether the putative power failure is an actual power service failure; and
using the at least one hardware processor, issuing an alert based on the determination of whether the putative power failure is an actual power service failure.

2. The method of claim 1, wherein the determination is that there is an actual power service failure, further comprising refraining from dispatching a remote technician to the remote network location based on the determination.

3. The method of claim 2, wherein the network monitoring location and the remote network location are connected by an enterprise wide area network.

4. The method of claim 2, wherein the network monitoring location and the remote network location are connected by at least one of a hybrid fiber-coaxial network, a fiber to the curb network, and a fiber to the home network, wherein the refraining is further responsive to obtaining an indication that the actual power service failure is projected to be over in a predetermined time period.

5. The method of claim 1, wherein the determination is that there is not an actual power service failure, further comprising dispatching a remote technician to the remote network location based on the determination.

6. The method of claim 5, wherein the network monitoring location and the remote network location are connected by an enterprise wide area network.

7. The method of claim 5, wherein the network monitoring location and the remote network location are connected by at least one of a hybrid fiber-coaxial network, a fiber to the curb network, and a fiber to the home network.

8. The method of claim 1, wherein the determination is that there is an actual power service failure, further comprising dispatching a remote technician to the remote network location based on the determination.

9. The method of claim 1, wherein the automated triage process includes checking whether a dying gasp message has been received from the remote network location.

10. The method of claim 1, wherein the automated triage process includes consulting a plurality of external resources via API calls.

11. The method of claim 1, wherein the automated triage process includes consulting a plurality of external resources via at least one of screen scraping and synthetic web interactions.

12. The method of claim 1, wherein the automated triage process includes checking at least one of a trap collector and a network monitoring toolset.

13. The method of claim 1, wherein the automated triage process includes consulting a plurality of external resources including one or more of third party power outage tracking web sites, power company text messages, subscription weather services, social media, emergency alert systems, and power company web sites.

14. The method of claim 13, wherein the automated triage process includes consulting at least social media, further comprising applying natural language processing with the at least one processor to understand sentiment of social media posts.

15. The method of claim 1, wherein determining whether the putative power failure is an actual power service failure is carried out with a rules-based correlation engine.

16. The method of claim 1, wherein determining whether the putative power failure is an actual power service failure is carried out with a machine learning-based correlation engine.

17. The method of claim 1, further comprising consulting a database to determine a geographic location of the remote network location, wherein the automated triage process includes consulting a plurality of external resources based on the determined geographic location.

18. The method of claim 1, wherein the automated triage process includes:
consulting at least one external resource providing a point location of a power failure; and
determining whether the remote network location is geographically proximate the point location.

19. The method of claim 1, further comprising determining a type of remote technician to dispatch to the remote network location based on the determination of whether the putative power failure is an actual power service failure.

20. The method of claim 1, further comprising implementing a daemon, an interface routine, and a correlation engine on the at least one processor, wherein:
the step of obtaining the indication of the putative power failure is carried out using the daemon;
the step of initiating the automated triage process is carried out using the correlation engine; and
the step of issuing the alert is carried out using the interface routine.

21. A non-transitory computer readable medium comprising computer executable instructions which when executed by a computer cause the computer to perform a method comprising the steps of:
obtaining, at a network monitoring location, an indication of a putative power failure at a remote network location;
responsive to obtaining the indication, initiating an automated triage process to determine whether the putative power failure is an actual power service failure; and
issuing an alert based on the determination of whether the putative power failure is an actual power service failure.

22. An apparatus comprising:
a memory; and
at least one processor, coupled to the memory, and operative to:
obtain, at a network monitoring location, an indication of a putative power failure at a remote network location;
responsive to obtaining the indication, initiate an automated triage process to determine whether the putative power failure is an actual power service failure; and
issue an alert based on the determination of whether the putative power failure is an actual power service failure.

23. The apparatus of claim 22, further comprising a network interface coupled to the at least one processor, wherein the network monitoring location is connected to the remote network location by an enterprise wide area network using the network interface.

24. The apparatus of claim 22, further comprising a network interface coupled to the at least one processor, wherein the network monitoring location is connected to the remote network location by at least one of a hybrid fiber-coaxial network, a fiber to the curb network, and a fiber to the home network using the network interface.

25. The apparatus of claim 22, wherein the automated triage process includes checking whether a dying gasp message has been received from the remote network location.

26. The apparatus of claim 22, wherein the automated triage process includes consulting a plurality of external resources via API calls.

27. The apparatus of claim 22, wherein the automated triage process includes consulting a plurality of external resources via at least one of screen scraping and synthetic web interactions.

28. The apparatus of claim 22, wherein the automated triage process includes checking at least one of a trap collector and a network monitoring toolset.

29. The apparatus of claim 22, further comprising a plurality of distinct software modules, each of the distinct software modules being embodied on a computer-readable storage medium, and wherein the distinct software modules comprise a daemon module, a correlation engine module, and an interface routine module;
wherein:
the at least one processor is operative to obtain the indication by executing the daemon module;
the at least one processor is operative to initiate the automated triage process by executing the correlation engine module; and
the at least one processor is operative to issue the alert by executing the interface routine module.

30. The apparatus of claim 29, wherein the correlation engine comprises a rules-based correlation engine.

31. The apparatus of claim 29, wherein the correlation engine comprises a machine learning-based correlation engine.

32. The apparatus of claim 29, wherein the distinct software modules further comprise a database module, wherein the at least one processor is further operative to consult the database to determine a geographic location of the remote network location, and wherein the automated triage process includes consulting a plurality of external resources based on the determined geographic location.
